(19) United States
(12) Patent Application Publication
(10) Pub. No.: US 2007/0199731 A1
(43) Pub. Date: Aug. 30, 2007

(54) Electrical cable protected against corrosion

(76) Inventor: Sophie Wasiuta, Sommaing Sur Ecaillon (FR)

Correspondence Address: SOFER & HAROUN LLP., 317 MADISON AVENUE, SUITE 910, NEW YORK, NY, 10017, US

(21) Appl. No.: 11/701,972

(22) Filed: Feb. 2, 2007

(30) Foreign Application Priority Data
Feb. 3, 2006 (FR) 06 50386

(51) Int. Cl. H01B 11/02

(52) U.S. Cl. 174/113 R

(57) ABSTRACT

The invention concerns a cable for transporting electricity, of the type comprising at least one insulated phase conductor, a neutral conductor and a shield, the shield surrounding the phase conductor and the neutral conductor and being adapted to be connected to a reference potential, a portion of the neutral conductor being in contact with a portion of the shield. The portions in contact consist of a material based on the same electrically conductive metal. According to the invention, the shield is of a metallic material covered with a layer of zinc and the neutral conductor is of aluminum covered with a layer of zinc. Applications include the transportation of electricity, more particularly at low voltage.

### RELATED APPLICATION

This application is related to and claims the benefit of priority from French Patent Application 06 50386, filed on Feb. 3, 2006, the entirety of which is incorporated herein by reference.

### BACKGROUND OF THE INVENTION

1. Field of the Invention

The present invention relates to a cable for transporting electricity, comprising a neutral conductor for grounding via a shield.

2. Description of the Prior Art

Electrical cables designed for transporting electricity, in particular for low voltages, generally comprise three phase conductors and one neutral conductor assembled together. Each phase or neutral conductor consists of one or more electrically conductive metal wires. Each of the phase conductors includes an insulative sheath around the wire or wires. The neutral conductor has no insulative sheath. A metal shield surrounds the phase and neutral conductors. This shield touches and is therefore in electrical contact with the (uninsulated) neutral conductor over practically all of its length. The shield and therefore the neutral conductor are connected to a reference potential, usually the ground potential for grounding. A protective jacket, generally of synthetic material, surrounds the shield.

Grounding the shield and the neutral conductor ensures good protection of third parties who might come into contact with the cable. These cables may be buried in fact and, during works, accidental contact of an electrically conductive tool with the cable is not excluded. Injuries, possibly fatal, are therefore to be feared. It is consequently primordial to ensure excellent grounding of these cables and therefore to design a particularly effective shield—neutral conductor system. Moreover, the shield must be mechanically strong so as not to be pierced or broken accidentally.

The cables must also resist corrosion caused by the environment, which may be polluted. The pollution may be air pollution in cable risers or pollution of the ground if the cable is buried. Corrosion may equally be initiated by entry of liquid (for example water) into the cable and, in conjunction with the metals constituting the neutral conductor and the shield, if those metals have relatively different electrochemical potentials, gives rise to what is known as the galvanic corrosion effect if the network is not electrically balanced or if there is a residual current in the neutral, for example.

The shield—neutral conductor system must also be reliable and have a long service life.

For reasons of lightness and price, the metal usually employed for the conductors is aluminum. However, this metal oxidizes naturally in contact with air to form a layer of alumina around the neutral conductor. Alumina being a relatively poor conductor of electricity, its formation is limited by depositing a layer of lead around the aluminum neutral conductor to ensure good electrical contact between the neutral conductor and the shield and to provide additional corrosion protection. However, because lead is toxic, it is no longer desirable to use it or any other heavy metal the use whereof is regulated.

U.S. Pat. No. 4,025,715 describes a solution for the protection of aluminum neutral conductors. That solution consists in coating the aluminum conductors with a semiconductor material charged with fine particles of carbon black. The coating may be effected by standard extrusion or molding processes using a plastic substance based on polymers charged with particles of carbon black.

Another method of preventing corrosion of aluminum conductors is described in Canadian patent CA 992364. That method consists in coating the conductor with a film of oleic acid.

The patent document EP 0 093 031 describes an electrical cable the shield of which may consist of aluminum bands and the bare neutral conductor of which may also be of aluminum. A sealing material, for example a powder that swells in contact with moisture, introduced between the conductors provides protection against longitudinal propagation of moisture and therefore protects against corrosion.

If the longitudinal propagation of water introduced into the cable is prevented by the presence of powder that swells in contact with moisture, such a cable has an unprotected bare neutral conductor. It can therefore easily corrode in the event of such pollution.

The present invention proposes an electrical cable that reduces the risk of electrocution of persons and animals through effective, reliable and corrosion-resistant grounding. Heavy metals such as lead are not used to protect the neutral conductor when it is of aluminum, thus avoiding possible pollution of the environment. Moreover, the neutral conductor of this cable is protected from any corrosion.

### SUMMARY OF THE INVENTION

More precisely, the invention consists in a cable for transporting electricity, of the type comprising at least one insulated phase conductor, a neutral conductor and a shield, the shield surrounding the phase conductor and the neutral conductor and being adapted to be connected to a reference potential, a portion of the neutral conductor being in contact with a portion of the shield, said portions consisting of a material based on the same electrically conductive metal, and the neutral conductor and the shield both being covered with a coating based on the same electrically conductive metal.

According to one advantageous embodiment, the neutral conductor is made of aluminum covered with zinc and the shield is made of a metallic material covered with a zinc coating.

Said a coating may be a film obtained by cold deposition of a polymerizable mixture consisting of an organic binder and pigments of said same electrically conductive metal, for example. The mixture preferably comprises at least 90% by volume of pigments of said metal.

Said coating may alternatively be a layer of said metal deposited by electrolysis.

According to an advantageous embodiment, the shield is in the form of a band placed around the phase conductor and the neutral conductor.

According to a preferred embodiment, the cable includes three insulated phase conductors, the shield surrounding the phase conductors and the neutral conductor.

The phase and neutral conductors may have a cylindrical or sector-shaped cross section, for example.

### BRIEF DESCRIPTION OF THE DRAWING

Other advantages and features of the invention will become apparent in the course of the following description of one embodiment of the invention, given by way of nonlimiting example and with reference to the appended drawing in which the single figure shows diagrammatically in cross section one embodiment of the invention.

### DETAILED DESCRIPTION OF THE PREFERRED EMBODIMENT

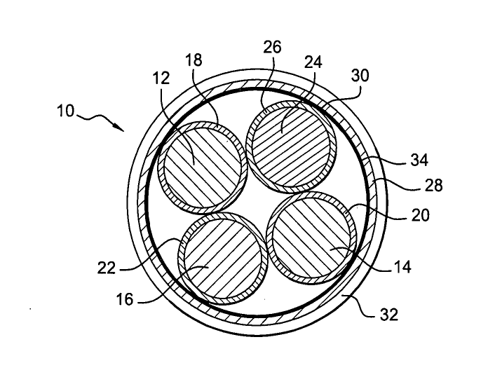

The cable 10 represented diagrammatically in cross section in FIG. 1 is intended for transporting three-phase low-voltage electricity. This cable includes three identical phase conductors 12, 14 and 16. Each is formed of a single metal wire or a plurality of stranded metal wires surrounded by a respective insulative sheath 18, 20 or 22. The metal wire or wires may be of aluminum, for example, or copper. The cable also includes a neutral conductor 24 consisting of one or more metal, preferably aluminum, wires. As already indicated, aluminum has the advantage of being a relatively good conductor of electricity, lighter and less costly than copper. It has the disadvantage of oxidizing on the surface to form a layer of relatively insulative alumina, however. To prevent this oxidation and possible corrosion, a thin layer 26 of a conductive material is deposited around the neutral conductor 24. The phase conductors 12, 14 and 16 and the neutral conductor 24 are assembled together.

A metal shield 28 envelops the assembly consisting of the four conductors over the whole of their length. This screen may for example take the form of a strip in the form of a conductive band placed around the four conductors over the whole of their length. The shield is in contact with a portion 30 of the conductive layer 26 of the neutral conductor 24. The latter assembled with the phase conductors and the shield 26 forming a relatively cylindrical assembly, the portions 30 in contact with the shield and the neutral conductor consist of a generatrix of the shield and the neutral conductor, respectively, of helicoidal or longitudinal shape. The shield 28 is intended to be connected to a reference potential, which is usually the ground potential so as to ground the shield. The neutral conductor 24, being in contact with the shield, is also connected to this reference potential.

A synthetic material protective jacket 32 surrounds the shield 28 over the whole of its length.

To achieve good protection of persons and animals, effective grounding is provided in accordance with the invention by choosing the same metal for the parts 30 in contact of the shield and the neutral conductor. This avoids the risk of corrosion of these parts and therefore of potential reduction in the quality of the electrical contact caused by a galvanic corrosion effect that occurs between metals with different electrochemical potentials. The shield and the neutral conductor may then consist of a conductive material based on the same metal. The latter metal could be copper, for example, or some other metal. However, the shield 28 is generally a metal band covered with a layer 34 that is usually of zinc. Moreover, as already indicated, the conductors are advantageously of aluminum, the neutral conductor being covered with a protective metal layer, usually of lead. According to a preferred embodiment of the invention, the layer of lead is replaced by a layer of zinc. There is then a cylindrical, galvanically protected shield 28 the interior portion 30 of which in contact with the neutral conductor is covered with a layer 34 of zinc and an aluminum neutral conductor 24 covered with a layer 26 of zinc. The parts in contact 30 are therefore of the same metal, namely zinc. A relatively simple metallurgical system in terms of chemical potentials is obtained in this way because the only chemical potentials operative are those of aluminum, zinc and the metal constituting the shield.

The layer of zinc can be deposited on the aluminum in various ways. The deposition may be effected cold, for example, by immersing the neutral conductor in a solution containing a small proportion of hydrocarbon-based organic binder and a majority of conductive pigments (or fine metal particles) of zinc. The solution preferably contains at least 90% by volume of zinc. The deposition may also be effected by evaporating the solution onto the aluminum. The film deposited in this way on the aluminum neutral conductor is then polymerized, for example by exposing it to moisture and/or to UV rays at room temperature. The film obtained is thin, with a thickness of the order of ten micrometers.

The thin layer of zinc may alternatively be deposited by electrolysis from a zinc-based solution. Layer thicknesses of the order of ten micrometers are also obtained, with a purity of the zinc exceeding 99.99%.

Deposition by immersion, evaporation or electrolysis produces a thin layer of zinc that is a good conductor of electricity and has beneficial mechanical deformation properties. In fact, winding tests have shown that the neutral conductor can be wound with a winding diameter substantially equal to five times its own diameter in one winding direction and then in the other without damaging, in particular without cracking, the zinc layer.

The invention proposes a novel solution for producing corrosion-resistant electrical cables that provide good protection against the risk of accidental electrocution through reliable grounding. The elimination of lead, and of heavy metals in general, prevents pollution of the environment. In particular, the embodiment comprising a ferrous metal shield covered with a layer of zinc and an aluminum neutral conductor covered with a layer of zinc retains the advantages of aluminum conductors (lightness, reduced cost) and the metal shields defined beforehand (good mechanical strength) at the same time as improving corrosion resistance and grounding.

The person skilled in the art may conceive of embodiments other than that described and shown without departing from the scope of the present invention. For example, the shield could consist of a non-ferrous band, for example of aluminum covered with a layer of zinc. Similarly, the phase and neutral conductors that have just been described have a substantially circular shape in cross section. In a different embodiment they could of course consist of conductors known as “sectoral” conductors, each having the shape of a sector in cross section. In this case, the phase conductors are substantially identical (the conductors having substantially the same shape and the same area in cross section), whereas the neutral conductor is generally of smaller section, although this is not obligatory.

There is claimed:

1. A cable for transporting electricity comprising:
at least one insulated phase conductor;
a neutral conductor; and
a shield, said shield surrounding said phase conductor and said neutral conductor and being adapted to be connected to a reference potential, a portion of said neutral conductor being in contact with a portion of said shield, said portions including a material based on the same electrically conductive metal, in which cable said neutral conductor and said shield are both covered with a coating based on the same electrically conductive metal.

2. A cable according to claim 1 wherein said electrically conductive metal is zinc.

3. A cable according to claim 1 wherein said coating is a film obtained by cold deposition of a polymerizable mixture having an organic binder and pigments of said same electrically conductive metal.

4. A cable according to claim 3 wherein said mixture includes at least 90% by volume of pigments of said metal.

5. A cable according to claim 1 wherein said coating is a layer of said metal deposited by electrolysis.

6. A cable according to claim 1 wherein said shield is in the form of a band deposited around said phase conductor and said neutral conductor.

7. A cable according to claim 1 including three insulated phase conductors, said shield surrounding said phase conductors and said neutral conductor.
